(19) United States
(12) Patent Application Publication
(10) Pub. No.: US 2008/0134829 A1
(43) Pub. Date: Jun. 12, 2008

(54) Connection assembly for connecting derailleur shifter to distal end of handlebar

(76) Inventor: Yung-Pin Kuo, Chang Hwa City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/700,945

(22) Filed: Feb. 1, 2007

(30) Foreign Application Priority Data
Dec. 7, 2006 (TW) 095221572

(51) Int. Cl. F16D 1/12

(52) U.S. Cl. 74/502.2

(57) ABSTRACT

A connection assembly for connecting a derailleur shifter to a distal end of a handlebar includes a locking part with a body and a clamping tube is connected to a first end of the body and a lug extends from a second end of the body. A connection member extends through the lug and is connected with a collar and the derailleur shifter. A groove is defined longitudinally through a wall of the body and the clamping tube which is mounted to the distal end of the handlebar. Two connection portions extend from the clamping tube and separated by the groove. A bolt extends through the tow connection portions to tightly clamp the clamping tube to the handlebar. An engaging portion connected to the body and includes a longitudinal slit with which a control cable is engaged.

### FIELD OF THE INVENTION

The present invention relates to a connection assembly for easily connecting a derailleur shifter to a distal end of a racing bicycle handlebar.

### BACKGROUND OF THE INVENTION

A conventional derailleur shifter 50 connected to a distal end of a racing bicycle handlebar 40 is shown in FIGS. 11 to 14 and generally includes a locking part 51 and a tubular portion 54 which is connected to a first end of the locking part 51, and a expandable portion 542 is connected to the distal end of the tubular portion 54. The expandable portion 542 is inserted into an end hole of the distal end of the handlebar 40 and a wrench is used to extend through an access hole 541 (FIG. 12) to expand the expandable portion 542 so as to connect the locking part 51 to the handlebar 40. The locking part 51 has a lug 53 extending from a second end thereof and a through hole 531 is defined through the lug 53. A connection member 55 extends through the through hole 531, a collar 56 and is fixed to the derailleur shifter 50. The derailleur shifter 50 includes a curved end which is engaged with a curved recess 52 defined in the second end of the locking part 51 and the control cable 41 extends through a hole 58 defined through the curved recess 52 and is connected to the derailleur shifter 50. A bolt 57 extends through the derailleur shifter 50 and is fixedly connected to the connection member 55.

However, the expandable-portion 542 has to be inserted into the handlebar 40 to connect the locking part 51 to the handlebar 40, and this limit the locking part 51 to be connected to a handlebar whose diameter is larger than the size that the expandable portion 542 can reach. Besides, if the wall of the handlebar 40 is too thin, the expandable portion 542 might break the wall. If the wall of the handlebar 40 is too thick, the weight will be too heavy to be used for a racing bicycle.

The present invention intends to provide a connection assembly which is connected with a derailleur shifter and easily clamps the handlebars of different sizes.

### SUMMARY OF THE INVENTION

The present invention relates to a connection assembly for connecting a derailleur shifter to a distal end of a handlebar and the connection assembly comprises a locking part with a body and a clamping tube and a lug respectively extend from two ends of the body. A connection member extends through a through hole in the lug and a collar is mounted to the lug and the derailleur shifter is connected to the connection member. A groove is defined longitudinally through two respective walls of the body and the clamping tube. Two connection portions extend from the clamping tube and are separated by the groove. The clamping tube is mounted on the handlebar and a bolt extends through the two connection portions to tighten the clamping tube. An engaging portion integrally extends from the body and includes a longitudinal slit so as to receive a control cable therein.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows that the locking part of the present invention is to be connected to the handlebar;

FIG. 2 shows a connection member is to be connected to the lug on the locking part of the present invention;

FIG. 3 shows that the derailleur shifter is to be connected to the locking part of the present invention;

FIG. 4 is a perspective view to show that the derailleur shifter is connected to the locking part of the present invention;

FIGS. 5 and 6 show that the control cable is engaged with the slit of the engaging portion on the locking part of the present invention;

FIG. 7 shows that the derailleur shifter on the locking part is connected to a handlebar of a racing bicycle;

FIG. 8 shows another embodiment of the connection assembly of the present invention;

FIG. 9A shows that the engaging member is to be snapped to the protrusion on the locking part of the present invention;

FIG. 9 shows that the engaging member is snapped to the protrusion on the locking part of the present invention;

FIG. 10 shows that the locking part and the handlebar are integrally made as one piece;

FIG. 11 shows that a conventional locking part is to be connected to a handlebar;

FIG. 12 shows a connection member is to be connected to the lug on the conventional locking part;

FIG. 13 shows that a derailleur shifter is to be connected to the conventional locking part, and

FIG. 14 shows that the derailleur shifter on the conventional locking part is connected to a handlebar of a racing bicycle.

### DETAILED DESCRIPTION OF THE PREFERRED EMBODIMENT

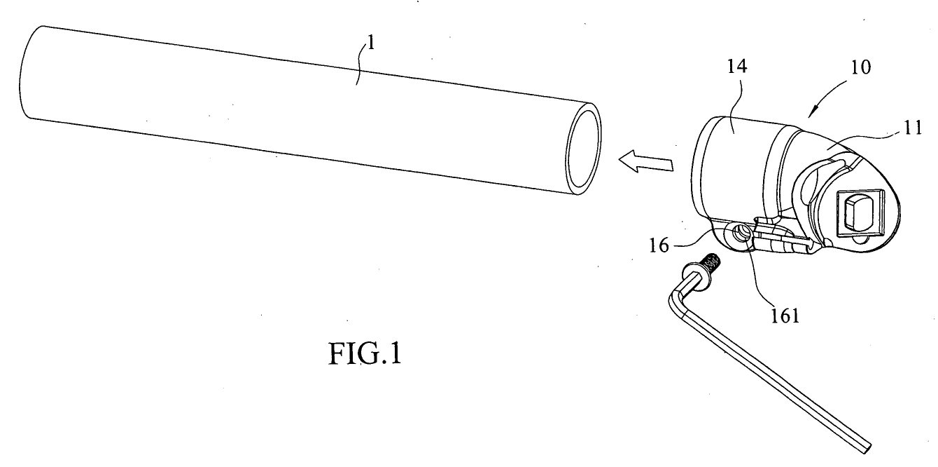

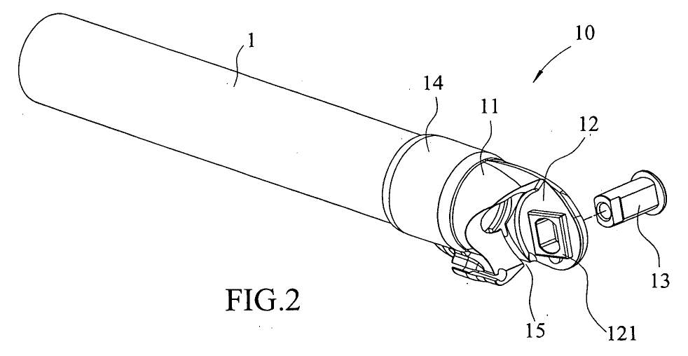

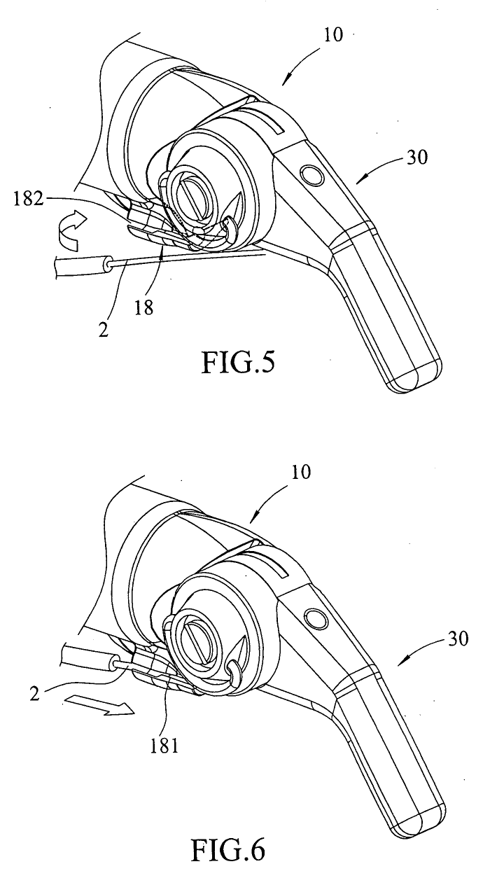

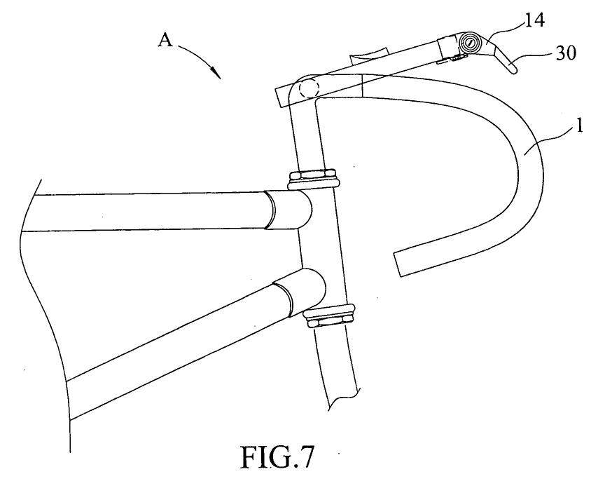

Referring to FIGS. 1 to 7, the connection assembly “A” for connecting a derailleur shifter 30 to a distal end of a handlebar 1 of a racing bicycle of the present invention comprises a locking part 10 which has a tubular body 11 and a clamping tube 14 is connected to a first end of the body 11 and a lug 12 extends from a second end of the body 11. A groove 15 is defined longitudinally through two respective walls of the body 11 and the clamping tube 14. Two connection portions 16 extend from the clamping tube 14 and separated by the groove 15. The clamping tube 14 is mounted on the handlebar 1 and a bolt extends through two threaded holes 161 in the two connection portions 16 to tighten the clamping tube 14 so that the locking part 10 is connected to the handlebar 1.

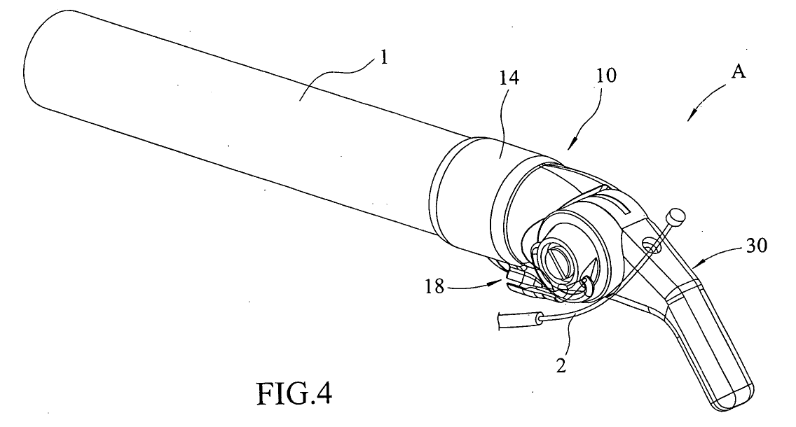

A through hole 121 is defined through the lug 12 and a connection member 13 with a rectangular cross section extends through the through hole 121. The connection member 13 extends through a collar 20 and the derailleur shifter 30 is connected to the connection member 13 by a bolt 131. A protrusion 17 extends from the body 11 and an engaging portion 18 is connected to the protrusion 17. The engaging portion 18 includes a passage 181 and a longitudinal slit 182 which is defined through a wall of the engaging portion 18 and communicates with the passage 181. An end of a control cable 2 extends through an aperture 31 defined in the derailleur shifter 30 and is securely engaged with the aperture 31 by an enlarged head, and the other end of the control cable 2 is easily engaged with the passage 181 via the longitudinal slit 182 as shown in FIGS. 4 to 6.

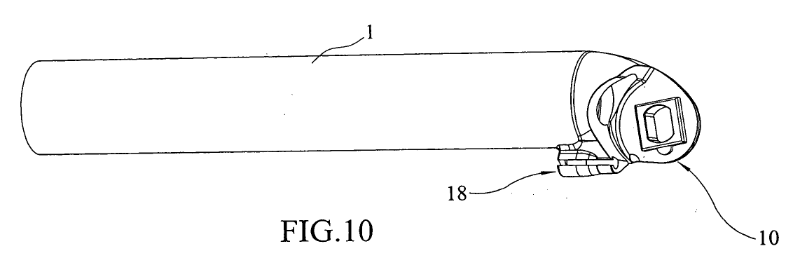

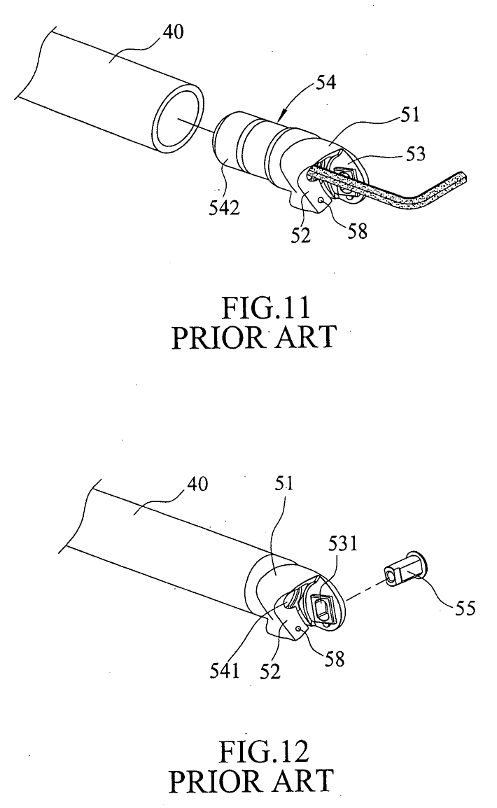

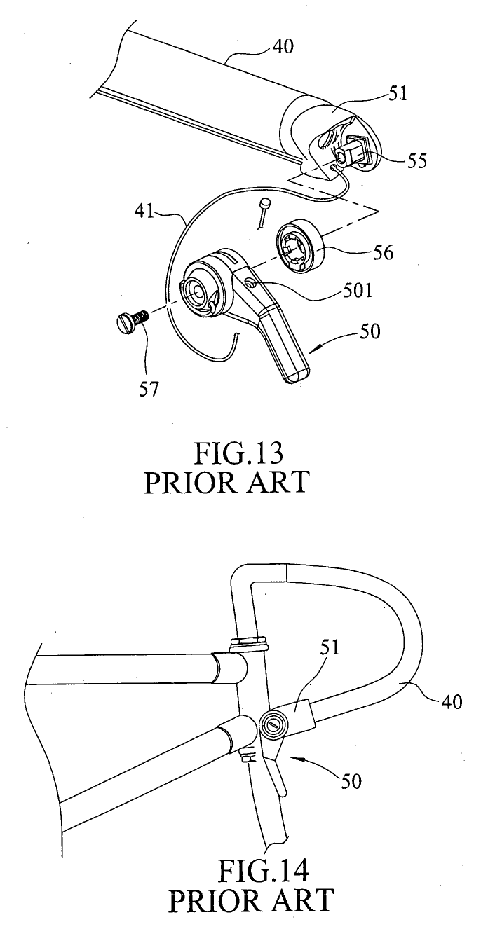

The clamping tube 14 includes a groove 5 so as to be easily mounted to handlebars 1 of different sizes and the bolt to secure the clamping tube 14 is conveniently installed from outside of the clamping tube 14. Of course, the handlebar 1 and the locking part 1 can be made integrally as one piece as shown in FIG. 10.

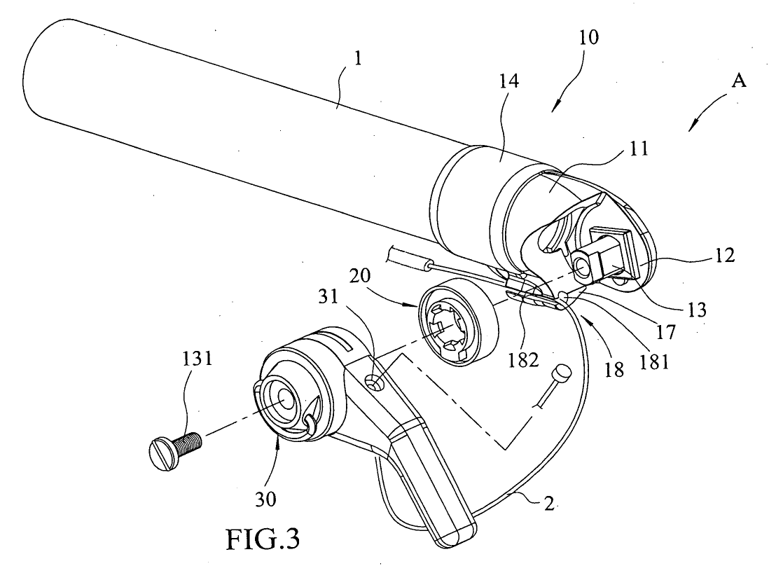

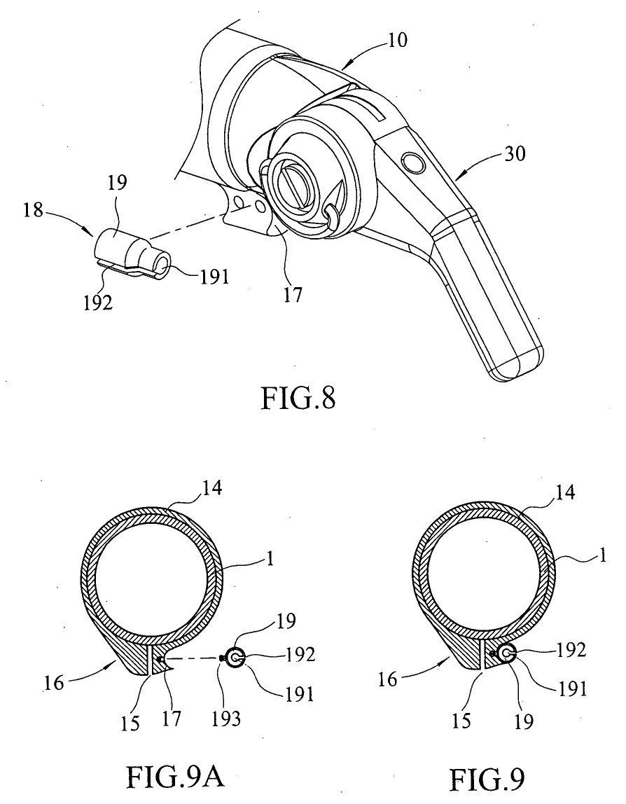

FIGS. 8, 9A and 9 show another embodiment of the engaging portion, wherein the engaging portion 18 as disclosed in FIG. 3 is replaced with an engaging member 19 which is removably connected to the body 11 and includes a passage 191 and a longitudinal slit 192 is defined through a wall of the engaging member 19 and communicates with the passage 191. A positioning member 193 extends radially from the engaging member 19 and the positioning member 193 is snapped to the protrusion 17. The control cable 2 is engaged with the passage 191 via the slit 192. The positioning member 193 can be made by different types of materials such as, metal, plastic or rubber.

While we have shown and described the embodiment in accordance with the present invention, it should be clear to those skilled in the art that further embodiments may be made without departing from the scope of the present invention.

What is claimed is:

1. A connection assembly for connecting a derailleur shifter to a distal end of a handlebar, comprising:
a locking part having a body and a clamping tube connected to a first end of the body, a lug extending from a second end of the body, a through hole defined through the lug and a connection member extending through the through hole, the connection member adapted to be connected with a collar and the derailleur shifter, a groove defined longitudinally through two respective walls of the body and the clamping tube, two connection portions extending from the clamping tube and separated by the groove, the clamping tube adapted to be mounted on the handlebar, a bolt extending through the two connection portions to tighten the clamping tube, an engaging portion integrally extending from the body and including a longitudinal slit which is adapted to receive a control cable.

2. The assembly as claimed in claim 1, wherein a protrusion extends from the body and the engaging portion is connected to the protrusion.

3. A connection assembly for connecting a derailleur shifter to a distal end of a handlebar, comprising:
a locking part having a body and a clamping tube connected to a first end of the body, a lug extending from a second end of the body, a through hole defined through the lug and a connection member extending through the through hole, the connection member adapted to be connected with a collar and the derailleur shifter, a groove defined longitudinally through two respective walls of the body and the clamping tube, two connection portions extending from the clamping tube and separated by the groove, the clamping tube adapted to be mounted on the handlebar, a bolt extending through the two connection portions to tighten the clamping tube, an engaging member removably connected to the body and including a longitudinal slit which is adapted to receive a control cable.

4. The assembly as claimed in claim 3, wherein a positioning member extends radially from the engaging member and a protrusion extends from the body, the positioning member is snapped to the protrusion.
